(19) United States
(12) Patent Application Publication
(10) Pub. No.: US 2025/0276899 A1
(43) Pub. Date: Sep. 4, 2025

(54) CARBON MATERIAL FOR LITHIUM SULFUR BATTERY AND PRODUCTION METHOD THEREFOR

(71) Applicant: NICHIA CORPORATION, Anan-shi (JP)

(72) Inventor: Akihiro TOKAI, Yokohama-shi (JP)

(73) Assignee: NICHIA CORPORATION, Anan-shi (JP)

(21) Appl. No.: 18/860,378

(22) PCT Filed: Apr. 21, 2023
(86) PCT No.: PCT/JP2023/015852

§ 371 Date: Oct. 25, 2024

(30) Foreign Application Priority Data
Apr. 27, 2022 (JP) 2022-073324

(51) Int. Cl. C01B 32/05; H01M 10/052

(52) U.S. Cl. CPC C01B 32/05; H01M 10/052; C01P 2004/03; C01P 2004/51; C01P 2004/61; C01P 2006/12; C01P 2006/14; C01P 2006/16; C01P 2006/40

(57) ABSTRACT

Provide is a method for producing a carbon material for a lithium sulfur battery with improved charge and discharge capacity. The method of producing a carbon material for a lithium-sulfur battery may include: performing a wet pulverization treatment of a mixture comprising a first carbon material, a dispersant, and a liquid medium to obtain a slurry; removing at least a portion of the liquid medium from the slurry to obtain a second carbon material; performing a heat treatment of the second carbon material to obtain a third carbon material; and performing an activation treatment of the third carbon material to obtain a fourth carbon material.

### TECHNICAL FIELD

The present disclosure relates to: a carbon material for a lithium-sulfur battery; and a method of producing the same.

### BACKGROUND ART

Lithium-sulfur batteries are secondary batteries having a high energy density per unit mass and, for example, mesoporous sulfur-carbon composites in which sulfur is arranged in mesopores are used therein. Such lithium-sulfur batteries are lighter than conventional lithium-ion batteries and thus expected to be used in, for example, large-sized power machine applications such as electric vehicles, and aviation applications such as drones. In these applications, an improvement in the cycle capacity retention rate, an improvement in the charge-discharge capacity, and the like are demanded.

In relation to the above, for example, Japanese Laid-Open Patent Publication No. 2015-220225 proposes a positive electrode material in which lithium sulfide and a carbon material are made into a composite.

### SUMMARY OF INVENTION

### Technical Problem

An object of an aspect of the disclosure is to provide a carbon material for a lithium-sulfur battery, with which a battery having an improved charge-discharge capacity may be configured; and a method of producing the same.

### Solution to Problem

A first aspect is a method of producing a carbon material for a lithium-sulfur battery, the method including: performing a wet pulverization treatment of a mixture containing a first carbon material, a dispersant, and a liquid medium to obtain a slurry; removing at least a portion of the liquid medium from the slurry to obtain a second carbon material; performing a heat treatment of the second carbon material to obtain a third carbon material; and performing an activation treatment of the third carbon material to obtain a fourth carbon material.

A second aspect is a carbon material for a lithium-sulfur battery, having: an average primary particle size that is 1.5 μm or less; a peak pore size in a range of 1.0 nm to 5.0 nm; a pore volume that is 0.6 ml/g or more; and a ratio D₉₀/D₁₀, which is a ratio of a 90% particle size D₉₀ with respect to a 10% particle size D₁₀ in a volume-based cumulative particle size distribution, that is 60 or higher.

A third aspect is a cathode material for a lithium-sulfur battery, containing: the carbon material for a lithium-sulfur battery according to the second aspect; and sulfur.

A fourth aspect is a positive electrode for a lithium-sulfur battery, including: a current collector; and a cathode active material layer which is arranged on the current collector and contains the cathode material for a lithium-sulfur battery according to the third aspect.

A fifth aspect is a positive electrode for a lithium-sulfur battery, including: a current collector; and a cathode active material layer arranged on the current collector. The cathode active material layer contains: a carbon material for a lithium-sulfur battery, which has an average primary particle size that is 1.5 μm or less; and a sulfur-containing positive electrode material for a lithium-sulfur battery, and the cathode active material layer has a porosity that is 10.0% or less.

### Advantageous Effects of Invention

According to an aspect of the present invention, the following may be provided: a carbon material for a lithium-sulfur battery, with which a battery having an improved charge-discharge capacity may be configured; and a method of producing the same.

### BRIEF DESCRIPTION OF DRAWINGS

FIG. 1 shows an example of a scanning electron microscope (SEM) image of the carbon material according to Example 1.

FIG. 2 shows an example of an SEM image of the carbon material according to Example 2.

FIG. 3 shows an example of an SEM image of the carbon material according to Example 3.

FIG. 4 shows an example of an SEM image of the carbon material according to Example 4.

FIG. 5 shows an example of an SEM image of the carbon material according to Example 5.

FIG. 6 shows an example of an SEM image of the carbon material according to Comparative Example 1.

FIG. 7 shows an example of an SEM image of the carbon material according to Comparative Example 2.

FIG. 8 shows an example of an SEM image of the carbon material according to Comparative Example 3.

FIG. 9 shows an example of an SEM image of the carbon material according to Comparative Example 4.

FIG. 10 shows the particle size distribution of the carbon material according to Example 1.

FIG. 11 shows the particle size distribution of the carbon material according to Comparative Example 1.

FIG. 12 shows the particle size distribution of the carbon material according to Comparative Example 2.

FIG. 13 shows an example of a cross-sectional SEM image of the positive electrode according to Example 1.

FIG. 14 shows an example of a cross-sectional SEM image of the positive electrode according to Example 2.

FIG. 15 shows an example of a cross-sectional SEM image of the positive electrode according to Example 3.

FIG. 16 shows an example of a cross-sectional SEM image of the positive electrode according to Example 4.

FIG. 17 shows an example of a cross-sectional SEM image of the positive electrode according to Example 5.

FIG. 18 shows an example of a cross-sectional SEM image of the positive electrode according to Comparative Example 1.

FIG. 19 shows an example of a cross-sectional SEM image of the positive electrode according to Comparative Example 2.

FIG. 20 shows an example of a cross-sectional SEM image of the positive electrode according to Comparative Example 3.

FIG. 21 shows an example of a cross-sectional SEM image of the positive electrode according to Comparative Example 4.

### DESCRIPTION OF EMBODIMENTS

The term “step” as used herein encompasses not only an independent step but also a step not clearly distinguishable from another step as long as the intended purpose of the step is achieved. If multiple substances correspond to a component in a composition, the content of the component in the composition means the total amount of the multiple substances present in the composition unless otherwise specified. Further, upper limit and lower limit values that are described for a numerical range in the present specification can be arbitrarily selected and combined. Embodiments of the present invention will now be described in detail. The embodiments described below are exemplifications of a carbon material for lithium-sulfur battery and the method of producing the same for embodying the technical ideas of the present invention, and the present invention is not limited to the carbon material for lithium-sulfur battery and the method of producing the same described below.

### Method of Producing Carbon Material for Lithium-Sulfur Battery

The method of producing a carbon material for a lithium-sulfur battery (hereinafter, may be simply referred to as “carbon material”) includes: the first step of performing a wet pulverization treatment of a mixture containing a first carbon material, a dispersant, and a liquid medium to obtain a slurry; the second step of removing at least a portion of the liquid medium from the slurry to obtain a second carbon material; the third step of performing a heat treatment of the second carbon material to obtain a third carbon material; and the fourth step of performing an activation treatment of the third carbon material to obtain a fourth carbon material. The thus obtained fourth carbon material may contain, for example, the desired carbon material for a lithium-sulfur battery, or may be a carbon material for a lithium-sulfur battery.

By the activation treatment of the third carbon material obtained by wet-pulverization of the first carbon material used as a raw material in the presence of a dispersant and subsequent drying and heat-treatment of the resultant, the fourth carbon material that has a smaller particle size, a broader particle size distribution, and an increased pore volume than the first carbon material used as a raw material may be obtained. When an electrode is formed using the thus obtained carbon material, a dense active material layer may be formed. In addition, since the peak pore size is in a prescribed range and the pore volume is large, elution of sulfur serving as an active material, which is caused by charging and discharging, may be inhibited while improving the reactivity of sulfur. It is believed that, as a result, the charge-discharge capacity of a lithium-sulfur battery to be constructed may be improved.

In the first step, a slurry is obtained by performing a wet pulverization treatment of a mixture containing a first carbon material, a dispersant, and a liquid medium.

In a volume-based cumulative particle size distribution, the first carbon material may have a 50% particle size D₅₀ of, for example, 1 μm to 1,000 μm, preferably 2 μm or more, or 4 μm or more, but preferably 100 μm or less, or 10 μm or less. The 50% particle size D₅₀ of the first carbon material is a particle size corresponding to a cumulative volume of 50% from the small particle size side in the volume-based cumulative particle size distribution, and it is measured under a wet condition using, for example, a laser diffraction-type particle size distribution analyzer.

The first carbon material may have a specific surface area of, for example, 100 m²/g or more, preferably 500 m²/g or more, 1,000 m²/g or more, or 1,500 m²/g or more. An upper limit of the specific surface area may be, for example, 4,000 m²/g or less, or 1,800 m²/g or less. The specific surface area of the first carbon material is measured by a BET (Brunauer Emmett Teller) method based on the BET theory. Specifically, the specific surface area of the first carbon material is measured by, for example, a multi-point method using nitrogen gas.

The first carbon material may have a peak pore size of, for example, 1.0 nm to 5.0 nm, preferably 1.4 nm or more, 1.6 nm or more, or 2.0 nm or more, but preferably 4.0 nm or less, 3.0 nm or less, or 2.5 nm or less. When the peak pore size of the first carbon material is in this range, the fourth carbon material tends to be provided with such a peak pore size that improves the charge-discharge capacity of a lithium-sulfur battery. It is noted here that the peak pore size refers to a pore diameter showing a maximum peak in a pore distribution curve determined by the quenched solid density functional theory (QSDFT) from a nitrogen adsorption isotherm obtained by nitrogen gas adsorption-desorption measurement.

The first carbon material may have a pore volume of, for example, 0.1 ml/g to 10 ml/g, preferably 0.3 ml/g or more, or 0.5 ml/g or more, but preferably 5 ml/g or less, 1 ml/g or less, or 0.8 ml/g or less. Particularly, the volume of pores having a diameter of 1.4 nm to 5.0 nm is preferably in the above-described range. When the pore volume of the first carbon material is in the above-described range, the fourth carbon material tends to be provided with such a pore volume that improves the charge-discharge capacity of a lithium-sulfur battery. The pore volume of the first carbon material is determined by, for example, nitrogen gas adsorption-desorption measurement.

The first carbon material may have a carbon content of, for example, 80% by mass or more, preferably 90% by mass or more, or 95% by mass or more, or the first carbon material may consist of substantially carbon. The term “substantially” used herein is intended not to exclude other elements that are unavoidably incorporated.

Specific examples of the first carbon material include activated carbons and carbon blacks. The first carbon material may contain at least an activated carbon.

The content of the first carbon material in the mixture may be, for example, 1% by mass to 50% by mass, preferably 2% by mass or more, or 3% by mass or more, but preferably 10% by mass or less, or 5% by mass or less, with respect to a total mass of the mixture. When the content of the first carbon material is in this range, the wet pulverization may be performed more efficiently.

Examples of the dispersant constituting the mixture include: thickening agents, such as a polyvinyl alcohol, a polyethylene glycol, carboxymethylcellulose, carboxyethylcellulose, starch, regenerated cellulose, ethylcellulose, hydroxymethylcellulose, hydroxyethylcellulose, and hydroxypropylcellulose; and surfactants, such as alkyl sulfates, alkylbenzene sulfonic acids, oil-soluble alkylbenzene sulfonic acids, α-olefin sulfonic acids, sodium alkylbenzene sulfonates, oil-soluble alkylbenzene sulfonates, and α-olefin sulfonates. The number-average molecular weight of the polyvinyl alcohol may be, for example, 900 to 100,000, preferably 5,000 or more, or 15,000 or less. The degree of saponification of the polyvinyl alcohol may be, for example, 50% by mole or more, preferably 60% by mole or more, 70% by mole or more, or 80% by mole or more.

The dispersant in the mixture may contain at least a thickening agent. When the dispersant contains a thickening agent, the wet pulverization tends to be performed more efficiently. The content of the dispersant in the mixture may be, for example, 0.5% by mass to 10% by mass, preferably 18 by mass or more, or 1.5% by mass or more, but preferably 5% by mass or less, or 3% by mass or less, with respect to a total mass of the mixture. Further, the content of the dispersant may be, for example, 10% by mass to 100% by mass, preferably 30% by mass or more, or 40% by mass or more, but preferably 80% by mass or less, or 60% by mass or less, with respect to a total mass of the first carbon material. When the content of the dispersant is in this range, the wet pulverization may be performed more efficiently.

The liquid medium constituting the mixture may contain at least water. The liquid medium, if necessary, may also contain a water-soluble organic solvent and the like in addition to water. Examples of the water-soluble organic solvent include: alcohol solvents, such as methanol, ethanol, and isopropyl alcohol; nitrile solvents, such as acetonitrile; ketone solvents, such as acetone and methyl ethyl ketone; and amide solvents such as N-methyl-2-pyrrolidone and N, N-dimethylformamide. The content of water in the liquid medium may be, for example, 10% by volume or more, preferably 50% by volume or more, or 90% by volume or more, with respect to a total volume of the liquid medium, or the liquid medium may consist of substantially water.

The mixture, if necessary, may further contain other components. Examples of the other components include a pH modifier, a surfactant, and a metal oxide. Examples of the pH modifier include: inorganic acids, such as hydrochloric acid, nitric acid, phosphoric acid, and sulfuric acid; organic acids, such as acetic acid, citric acid, and oxalic acid; inorganic bases, such as alkali metal hydroxides and alkaline earth metal hydroxides; and ammonia. Examples of the metal oxide include oxides containing a transition metal, such as titanium oxide and tungsten oxide. The metal oxide may contain a compound complexed with an alkali metal, an alkaline earth metal, or the like. Examples of the complexed compound include lithium titanate and lithium tungstate. The mixture may contain an organic acid as a pH modifier. When the mixture contains a pH modifier, the content thereof may be selected as appropriate in accordance with the desired pH.

The mixture may be prepared by, for example, mixing the first carbon material, the dispersant, the liquid medium and, if necessary, other components such as a pH modifier. As a mixing method, any mixing method that is generally employed, for example, a method using a bead mill, a ball mill, a homogenizer, or a shear mixer such as a planetary mixer may be employed. The mixing method may double as the wet pulverization treatment.

The wet pulverization treatment of the mixture may be performed using, for example, a bead mill or a ball mill. When a bead mill is used for the wet pulverization treatment, beads are added to the mixture. Examples of the material of the beads to be added include zirconium oxide. The beads may have a particle size of, for example, 0.1 mm to 3 mm, preferably 0.5 mm or more, or 1.5 mm or less. In the pulverization treatment, beads having different particle sizes may be used in combination. For example, when two kinds of beads having different particle sizes are used, a particle size ratio, which is a ratio of a smaller bead particle size with respect to a larger bead particle size, may be, for example, 0.1 to 0.9, preferably 0.5 or higher, or 0.7 or lower. Further, when two kinds of beads having different particle sizes are used, their volume-based mixing ratio (beads with larger particle size: beads with smaller particle size) may be, for example, 10:1 to 1:10, or 2:1 to 1:2. A ratio of a total volume of the beads with respect to a total volume of the mixture may be, for example, 0.1 to 1, preferably 0.5 or higher, or 0.7 or lower.

The duration of the wet pulverization treatment may be, for example, 1 hour to 200 hours, preferably 10 hours or longer, or 20 hours or longer, but preferably 130 hours or shorter, 90 hours or shorter, or 50 hours or shorter. The ambient temperature in the wet pulverization treatment may be, for example, 15° C. to 40° C., preferably 20° C. or higher, or 30° C. or lower. The atmosphere of the wet pulverization treatment may be, for example, an air atmosphere.

When a bead mill is used for the wet pulverization treatment of the mixture, the beads may be removed after the wet pulverization treatment to obtain a slurry. The carbon material contained in the resulting slurry may have a volume-average particle size of, for example, 1 μm to 10 μm, preferably 2 μm or more, or 7 μm or less. It is noted here that the volume-average particle size is a 50% particle size D₅₀ corresponding to a cumulative volume of 50% from the small particle size side in a volume-based cumulative particle size distribution.

In the second step, a second carbon material is obtained by a drying treatment of removing at least a portion of the liquid medium from the slurry. The liquid medium can be removed from the slurry by, for example, a heat-drying treatment, a spray-drying treatment, or a coagulant addition treatment.

The heat-drying treatment can be performed by, for example, removing a portion of the liquid medium by filtration of the slurry to obtain a wet cake, and subsequently performing a heat treatment of the thus obtained wet cake. The filtration of the slurry may be performed by, for example, suction filtration. The removal of the liquid medium by filtration is sufficient as long as, for example, not less than 90% by volume, preferably not less than 95% by volume of the liquid medium contained in the slurry can be removed. In the removal of the liquid medium by filtration, if necessary, a washing treatment with other liquid medium such as water may be performed as well.

The temperature of the heat treatment of the wet cake may be, for example, 50° C. to 200° C., preferably 100° C. or higher, or 150° C. or lower. Further, the atmosphere of the heat treatment may be, for example, an air atmosphere. The heat treatment of the wet cake can be performed using, for example, a constant-temperature dryer. In the heat-drying treatment, if necessary, a crushing treatment, a classification treatment, and the like may be performed after the heat treatment.

The spray-drying treatment is a drying treatment of obtaining a particulate product by drying the slurry while scattering the slurry in the form of small-size particles with the use of a gas flow. Accordingly, as a dryer that can be used for the spray-drying treatment, one having both a spraying function and a drying function may be selected. Examples of such a dryer include not only so-called spray-drying-type dryers, but also various dryers such as air flow dryers and fluidized bed dryers. The drying temperature in the spray-drying treatment may be, for example, 80° C. to 150° C., preferably 90° C. or higher, or 130° C. or lower.

In the spray-drying treatment, a gas is supplied to the dryer for the purposes of, for example, spraying and drying the slurry. As for the type of the gas to be supplied, the gas may be air or an inert gas, for example, nitrogen gas or a noble gas such as argon gas. The use of an inert gas makes it easier to perform the spray-drying treatment, regardless of the type of the liquid medium of the slurry.

The drying treatment in the second step may include at least the spray-drying treatment. In other words, the second carbon material obtained in the second step may contain a spray-dried product. When the second carbon material contains a spray-dried product, the handling of the dried product tends to be improved.

The second carbon material obtained in the second step may have an average primary particle size of, for example, 1.5 μm or less, preferably 1.4 μm or less, or 1.3 μm or less, but preferably 0.4 μm or more, or 0.5 μm or more. When the average primary particle size of the second carbon material is in this range, the fourth carbon material tends to be provided with such an average primary particle size that improves the charge-discharge capacity of a lithium-sulfur battery. The average primary particle size of the second carbon material is determined by measuring the particle sizes of plural primary particles on a scanning electron microscope (SEM) image and calculating the arithmetic mean of the measured values. Specifically, on an SEM image, plural (e.g., 200) primary particles each having a recognizable outline are selected, and the sizes of the selected primary particles are measured in terms of the longest distance between two points on the outline (maximum Feret diameter). The average primary particle size is calculated as an arithmetic mean value of the thus measured particle sizes of the primary particles. The term “recognizable outline” used herein means that the entire circumference of the outline of the primary particle of interest can be traced on the SEM image.

In the third step, a third carbon material is obtained by performing a heat treatment of the second carbon material. The heat treatment in the third step may include: the temperature raising step of raising the temperature to a prescribed heat treatment temperature; the temperature maintaining step of maintaining the prescribed heat treatment temperature; and the temperature lowering step of lowering the temperature from the prescribed heat treatment temperature. In the temperature raising step, for example, the temperature is raised from room temperature to the prescribed heat treatment temperature. A temperature raising rate may be, for example, 3° C./min to 8° C./min. In the temperature maintaining step, the prescribed heat treatment temperature is maintained over a prescribed heat treatment time. The heat treatment temperature in the third step may be, for example, 600° C. to 1,500° C., preferably 800° C. or higher, or 900° C. or higher, but preferably 1,200° C. or lower, or 1,100° C. or lower. The heat treatment time may be, for example, 1 hour to 10 hours, preferably 3 hours or longer, or 4 hours or longer, but preferably 7 hours or shorter, or 6 hours or shorter. In the temperature lowering step, for example, the temperature is lowered from the prescribed heat treatment temperature to room temperature. A temperature lowering rate may be, for example, 0.1° C./min to 50° C./min.

The atmosphere of the heat treatment may be an inert gas atmosphere of, for example, a noble gas such as nitrogen gas or argon gas. The atmosphere of the heat treatment may have an oxygen concentration of 20% by volume or lower, preferably 1% by volume or lower.

The heat treatment in the third step may be performed using, for example, a tube furnace, a box furnace, a roller hearth kiln, or a rotary kiln.

In the fourth step, a fourth carbon material is obtained by performing an activation treatment of the third carbon material. An activation treatment of a carbon material generally means a treatment of gasifying volatile components, carbon atoms, and the like contained in the carbon material at a high temperature using a gas, a chemical, or the like, thereby developing a microporous structure. The activation treatment encompasses a gas activation method using an activating gas, and a chemical activation method using an activating chemical. Examples of a gas used in the gas activation method include water vapor, carbon dioxide, air, and oxygen. Further, examples of an activator used in the chemical activation method include: alkali metal hydroxides, such as potassium hydroxide and sodium hydroxide; and metal halides such as zinc chloride.

The temperature of the activation treatment may be, for example, 650° C. to 900° C., preferably 700° C. or higher, or 720° C. or higher, but preferably 850° C. or lower, or 800° C. or lower. The duration of the activation treatment may be, for example, 30 minutes to 5 hours, preferably 1 hour or longer, or 1.5 hours or longer, but preferably 3 hours or shorter, or 4 hours or shorter.

From the standpoint of increasing the pore volume, the activation treatment applied to the fourth step may include, for example, a chemical activation method, preferably a chemical activation method using an alkali metal hydroxide. When the activation treatment of the third carbon material includes a chemical activation method, the activation treatment in the fourth step may include: the mixing step of mixing the third carbon material with an activator to obtain a mixture; and the activation step of performing a heat treatment of the thus obtained mixture to obtain a fourth carbon material.

In the mixing step, a mixture is obtained by mixing the third carbon material with an activator. In the mixture, a mass ratio of the activator with respect to the third carbon material (activator/third carbon material) may be, for example, 1 or higher, preferably 2 or higher, or 3 or higher, but preferably 6 or lower, or 5 or lower. Examples of a method of mixing the third carbon material with the activator include a mechanical mixing method.

In the activation step, a fourth carbon material is obtained by performing a heat treatment of the mixture containing the third carbon material and the activator. The activation step may include: raising the temperature to a prescribed activation treatment temperature; maintaining the prescribed activation treatment temperature; and lowering the temperature from the prescribed activation treatment temperature. A rate of raising the temperature to the activation treatment temperature may be, for example, 8° C./min to 18° C./min. The activation treatment temperature may be, for example, 650° C. to 900° C., preferably 700° C. or higher, or 720° C. or higher, but preferably 850° C. or lower, or 800° C. or lower. The activation treatment time may be, for example, 30 minutes to 5 hours, preferably 1 hour or longer, or 1.5 hours or longer, but preferably 4 hours or shorter, or 3 hours or shorter. A rate of lowering the temperature from the activation treatment temperature may be, for example, 0.1° C./min to 50° C./min.

The atmosphere of the activation step may be an inert gas atmosphere of, for example, nitrogen gas or a noble gas such as argon gas. The atmosphere of the activation step may have an oxygen concentration of 20% by volume or lower, preferably 1% by volume or lower.

The fourth step may also include the pre-heat treatment step before the activation step. In the pre-heat treatment step, a pre-heated product is obtained by performing a heat treatment of the mixture containing the third carbon material and the activator at a temperature of, for example, 250° C. or higher but lower than 650° C. The pre-heat treatment step may include: raising the temperature to a prescribed pre-heat treatment temperature; maintaining the prescribed pre-heat treatment temperature; and lowering the temperature from the prescribed pre-heat treatment temperature. A rate of raising the temperature to the pre-heat treatment temperature may be, for example, 5° C./min to 20° C./min, or 8° C./min to 15° C./min. The pre-heat treatment temperature may be preferably 300° C. or higher, or 350° C. or higher, but preferably 550° C. or lower, or 450° C. or lower. The pre-heat treatment time may be, for example, 10 minutes to 3 hours, preferably 30 minutes to 50 minutes, but preferably 2 hours or shorter, or 1.5 hours or shorter. A rate of lowering the temperature from the pre-heat treatment temperature may be, for example, 0.1° C./min to 50° C./min.

The atmosphere of the pre-heat treatment step may be an inert gas atmosphere of, for example, nitrogen gas or a noble gas such as argon gas. The atmosphere of the pre-heat treatment step may have an oxygen concentration of 20% by volume or lower, preferably 18 by volume or lower.

If necessary, the fourth carbon material obtained in the fourth step may be subjected to, for example, a washing treatment, a crushing treatment, and a classification treatment.

The washing treatment may include, for example: bringing the fourth carbon material obtained in the activation step into contact with an acidic solution; and bringing the fourth carbon material, which has thus been brought into contact with the acidic solution, into contact with a liquid medium containing water.

A contact between the fourth carbon material and the acidic solution can be made by, for example, mixing the fourth carbon material with the acidic solution. The temperature of the contact between the fourth carbon material and the acidic solution may be, for example, 15° C. to 40° C. The duration of the contact may be, for example, 1 minute to 1 hour. The acidic solution may contain an acidic compound and a liquid medium containing at least water. Examples of the acidic compound include hydrochloric acid and nitric acid. The concentration of the acidic compound in the acidic solution may be, for example, 0.1 mol/l to 2 mol/l, preferably 0.5 mol/l or higher, or 1.5 mol/l or lower. At least a portion of the acidic solution may be removed by filtration or the like from the fourth carbon material brought into contact with the acidic solution.

A contact between the fourth carbon material and the liquid medium containing water can be made by, for example, mixing the fourth carbon material with the liquid medium containing water. The temperature of the contact between the fourth carbon material and the liquid medium may be, 15° C. to 40° C. The liquid medium is sufficient as long as it contains water, and the liquid medium may be substantially water. The term “substantially” used herein means that unavoidably incorporated components other than water are not excluded, and the content of water in the liquid medium may be, for example, 90% by mass or more, or 95% by mass or more. A contact between the fourth carbon material and the liquid medium containing water can also be made by, for example, passing the liquid medium containing water through the fourth carbon material maintained on a funnel. In this case, the contact between the fourth carbon material and the liquid medium containing water may be made by passing the liquid medium through the fourth carbon material until the resulting filtrate has a pH of, for example, 5 to 7, preferably 6 or higher.

After the washing treatment, the fourth carbon material may also be subjected to a drying treatment. The drying temperature in this drying treatment may be, for example, 120° C. to 160° C. Further, the drying time may be, for example, 10 hours to 24 hours.

### Carbon Material for Lithium-Sulfur Battery

The carbon material for a lithium-sulfur battery has: an average primary particle size of 1.5 μm or less; a peak pore size of 1.0 nm to 5.0 nm; a pore volume of 0.6 ml/g or more; and a ratio D₉₀/D₁₀, which is a ratio of a 90% particle size D₉₀ corresponding to a cumulative volume of 90% from the small particle size side with respect to a 10% particle size D₁₀ corresponding to a cumulative volume of 10% from the small particle size side in a volume-based cumulative particle size distribution, of 60 or higher.

The carbon material for a lithium sulfur battery has a small average primary particle size of 1.5 μm or less and a large pore volume of 0.6 ml/g or more, and can thus improve the charge-discharge capacity of a lithium-sulfur battery to which the carbon material is applied. The reason for this is believed to be, for example, as follows. The small average primary particle size leads to a short diffusion distance of lithium ions in the pores, so that an increase in the internal resistance caused by charging and discharging can be reduced. In addition, because of the large pore volume, spaces that allow sulfur in the pores to expand and contract can be created, so that the elution of sulfur into an electrolyte solution during charging and discharging is made unlikely to occur, and a charge-discharge reaction proceeds efficiently. Further, the high D₉₀/D₁₀ ratio leads to a broad particle size distribution, and small particles are incorporated into interparticle voids at the time of forming a positive electrode active material layer, so that the porosity of the resulting positive electrode active material layer is reduced, and the packing property of the particles is improved. It is believed that, as a result, the charge-discharge capacity of the lithium-sulfur battery can be improved.

The average primary particle size of the carbon material for a lithium-sulfur battery may be, for example, 1.5 μm or less, preferably 1.4 μm or less, or 1.3 μm or less, more preferably 1.0 μm or less, or 0.9 μm or less. A lower limit of the average primary particle size may be, for example, 0.5 μm or more, 0.6 μm or more, or 0.8 μm or more. The average primary particle size of the carbon material for a lithium-sulfur battery is calculated in the same manner as the average primary particle size of the second carbon material.

The peak pore size of the carbon material for a lithium-sulfur battery may be, for example, 1.0 nm to 5.0 nm, preferably 1.4 nm or more, or 2.0 nm or more, but preferably 4.0 nm or less, 3.5 nm or less, 3.0 nm or less, or 2.5 nm or less. When the peak pore size of the carbon material for a lithium-sulfur battery is in this range, sulfur is unlikely to elute into an electrolyte solution, so that the charge-discharge capacity tends to be increased. The peak pore size of the carbon material for a lithium-sulfur battery is determined by nitrogen gas adsorption-desorption measurement as described above.

The pore volume of the carbon material for a lithium-sulfur battery may be, for example, 0.6 ml/g or more, preferably 0.7 ml/g or more, 0.8 ml/g or more, or 0.9 ml/g or more, but preferably 1.4 ml/g or less, 1.3 ml/g or less, or 1.1 ml/g or less. Particularly, the volume of pores having a diameter of 1.4 nm to 5.0 nm is preferably in the above-described range. When the pore volume of the carbon material for a lithium-sulfur battery is in the above-described range, a volume sufficient for expansion and contraction of sulfur is obtained at the time of entrapping sulfur into pores, so that the charge-discharge capacity tends to be increased. The pore volume of the carbon material for a lithium-sulfur battery is determined by nitrogen gas adsorption-desorption measurement as described above.

The carbon material for a lithium-sulfur battery may have a specific surface area of, for example, 1,000 m²/g or more, preferably 1,300 m²/g or more, 1,400 m²/g or more, 1,500 m²/g or more, 1,800 m²/g or more, or 2,000 m²/g or more. An upper limit of the specific surface area may be, for example, 2, 500 m²/g or less, or 2,200 m²/g or less.

In the volume-based cumulative particle size distribution, the carbon material for a lithium-sulfur battery may have a 50% particle size D₅₀ of, for example, 2 μm to 10 μm, preferably 2.5 μm or more, or 4 μm or more, but preferably 8 μm or less, or 7 μm or less.

The carbon material for a lithium-sulfur battery may have a 10% particle size D₁₀ of, for example, 1 μm or less, preferably 0.9 μm or less, or 0.8 μm or less, more preferably 0.6 μm or less, 0.4 μm or less, or 0.2 μm or less, but preferably 0.1 μm or more. When the 10% particle size D₁₀ is in this range, small particles are incorporated into voids between particles at the time of forming a positive electrode active material layer, so that the packing property of the particles is improved. Further, the carbon material for a lithium-sulfur battery may have a 90% particle size D₉₀ of, for example, 50 μm or more, preferably 70 μm or more, or 80 μm or more, but preferably 160 μm or less, or 170 μm or less.

In the carbon material for a lithium-sulfur battery, the ratio D₉₀/D₁₀ of the 90% particle size D₉₀ with respect to the 10% particle size D₁₀ may be, for example, 60 or higher, preferably 500 or higher, or 600 or higher. An upper limit of the ratio D₉₀/D₁₀ may be, for example, 1,300 or lower, or 1,200 or lower. The volume-based cumulative particle size distribution is measured under a wet condition using a laser diffraction-type particle size distribution analyzer. Further, the 10% particle size D₁₀, the 50% particle size D₅₀, and the 90% particle size D₉₀ are measured as particle sizes corresponding to a cumulative volume of 10%, 50%, and 90%, respectively.

The carbon material for a lithium-sulfur battery is configured to contain at least carbon. The carbon content in the carbon material for a lithium-sulfur battery may be, for example, 70% by mass or more, preferably 80% by mass or more, or 90% by mass or more, and the carbon material for a lithium-sulfur battery may consist of substantially carbon. The term “substantially” used herein is intended not to exclude other elements that are unavoidably incorporated.

The carbon material for a lithium-sulfur battery may further contain other elements in addition to carbon. Examples of the other elements include: main-group elements typified by nitrogen, oxygen, alkali metals, and the like; and transition metal elements. Examples of the alkali metal elements include potassium. An alkali metal such as potassium contained in the carbon material may originate from a carbon raw material, an activator, or the like. The content of potassium varies depending on a raw material, activation treatment conditions, washing conditions, and the like; however, it may be, for example, 1,500 ppm or more, or 3,000 ppm or more, but 10,000 ppm or less, or 6,000 ppm or less. Examples of the transition metal elements include zirconium. A transition metal element such as zirconium contained in the carbon material may originate from beads, container, or the like used for wet pulverization. The content of zirconium tends to be increased in proportion to the duration of the treatment using a bead mill. This is believed to be because zirconium constituting the beads are adhered to the carbon material. The content thereof may be 20 ppm or more, or 100 ppm or more, but may be 400 ppm or less, or 200 ppm or less. The content of a metal element in the carbon material can be measured by, for example, inductively-coupled plasma (ICP) emission spectroscopy.

### Cathode Material for Lithium-Sulfur Battery

The cathode material for a lithium-sulfur battery contains: the above-described carbon material for a lithium-sulfur battery (hereinafter, also simply referred to as “carbon material”); and a material containing a sulfur element, which is adhered to the carbon material. The material containing a sulfur element may be adhered to the voids of the carbon material. The carbon material has a large specific surface area and a large pore volume; therefore, it may increase the battery capacity.

Examples of the material containing a sulfur element include elemental sulfur, and polysulfides generated during a charge-discharge process of a lithium-sulfur battery. Specific examples of the material containing a sulfur element include S₈, Li₂S₈, Li₂S₆, Li₂S₄, and Li₂S₂, among which elemental sulfur (S₈) is preferred from the standpoint of yield.

In a sulfur-carbon composite, the content of the material containing a sulfur element that is arranged in the voids of the carbon material may be, for example, 25% by mass to 95% by mass, preferably 45% by mass to 55% by mass, in terms of a ratio of the mass of the material containing a sulfur element with respect to a total mass of the carbon material and the material containing a sulfur element. When the content of the material containing a sulfur element is in the above-described range, deterioration in the capacity of the sulfur-carbon composite is reduced.

### Positive Electrode for Lithium-Sulfur Battery

The positive electrode for a lithium-sulfur battery (hereinafter, also simply referred to as “positive electrode”) includes: a current collector; and a cathode active material layer arranged on the current collector. The cathode active material layer may contain the above-described cathode material for a lithium-sulfur battery. The positive electrode is produced by, for example, applying an electrode composition, which contains the above-described positive electrode material for a lithium-sulfur battery, a liquid medium, a binder, a conductive agent, and the like, onto a current collector, and subsequently drying and press-molding the resultant to form a cathode active material layer on the current collector.

As the liquid medium, for example, an organic solvent or water may be used in accordance with the intended use. Examples of the organic solvent include: amide-based solvents, such as N-methyl-2-pyrrolidone (NMP); ketone-based solvents, such as diisopropyl ketone, diisobutyl ketone, and methyl ethyl ketone; hydrocarbon-based solvents, such as heptane; ether-based solvents, such as tetrahydrofuran, dimethoxyethane, and dioxolane; amine-based solvents, such as diethylenetriamine; and ester-based solvents. These organic solvents may be used singly, or in combination of two or more kinds thereof. The content of the liquid medium may be, for example, 10% by mass to 90% by mass, with respect to a total mass of the electrode composition.

The binder is a material that helps, for example, the adhesion of the cathode active material with the conductive agent and the like, and the adhesion of the electrode composition to the current collector. Examples of the binder include polyvinylidene fluoride (PVDF), polyvinyl alcohol, carboxymethylcellulose (CMC), starch, hydroxypropylcellulose, regenerated cellulose, polyvinylpyrrolidone, tetrafluoroethylene, polyethylene, polypropylene, ethylene-propylene-diene rubber (EPDM), sulfonated EPDM, styrene-butylene rubber, fluororubber, and various copolymers. The content of the binder may be, for example, 0.05% by mass to 50% by mass, with respect to a total mass of the electrode composition.

The conductive agent is a material that improves, for example, the electrical conductivity of a cathode composition layer. Examples of the conductive agent include: graphites, such as modified graphene, natural graphite, and artificial graphite; carbon blacks, such as acetylene black, Ketjen black, channel black, furnace black, lamp black, and thermal black; conductive fibers, such as carbon fibers and metal fibers; and carbon materials, such as graphene and carbon nanotubes. The content of the conductive agent may be, for example, 0.5% by mass to 30% by mass, with respect to a total mass of the electrode composition.

Examples of the current collector include: metals, such as copper, stainless steel, aluminum, nickel, and titanium; composite materials obtained by treating the surface of copper, stainless steel, or the like with carbon, nickel, titanium, silver, or the like; and carbon foils. In the case of producing a lightweight lithium-sulfur battery, aluminum or a carbon foil is preferred as a lightweight current collector. By forming fine irregularities on the surface of the current collector, the adhesive strength of the current collector with a cathode composition layer and the like can be improved. Further, the current collector may take various forms, such as a film, a sheet, a foil, a net, a porous body, a foam, and a nonwoven fabric. The current collector may have a thickness of, for example, 3 μm to 500 μm.

The cathode active material layer configured to contain the above-described positive electrode material for a lithium-sulfur battery may be formed as a dense layer having few voids. In the positive electrode, the cathode active material layer may have a porosity of, for example, 10.0% or less, preferably 9.0% or less, 6.0% or less, 5.0% or less, or 3.0% or less. A lower limit of the porosity of the cathode active material layer may be, for example, 1% or more. The porosity of the cathode active material layer is determined by specifying a prescribed area on a cross-sectional SEM image of the cathode active material layer, and measuring the area ratio of voids therein using an image analysis software.

### Lithium-Sulfur Secondary Battery

The lithium-sulfur battery includes the above-described positive electrode for a lithium-sulfur battery. The lithium-sulfur battery is configured to include, for example: the positive electrode for a lithium-sulfur battery; a negative electrode; and an electrolyte arranged between the positive electrode and the negative electrode. If necessary, the lithium-sulfur battery may also include a separator. The electrolyte may be contained in the positive electrode for a lithium-sulfur battery, the negative electrode, and the separator.

### Negative Electrode

As the negative electrode constituting the lithium-sulfur battery, any known negative electrode may be used. Examples of a negative electrode material constituting the negative electrode include Li metal, Li—Si alloys, Li—Al alloys, Li—In alloys, lithium titanate (e.g., Li₄Ti₅O₁₂ and LiTi₂O₄), lithium-titanium composite oxides (e.g., Li₄Ti₅₋ₓMnₓO₁₂; 0<x≤0.3), and LiₓC (x≤6). In these negative electrode materials, lithium may be partially substituted with other alkali metal. As the negative electrode material, Li metal, Li—Si alloys, Li—Al alloys, Li—In alloys, LiₓC (x≤6), and the like are preferred. By using any of these materials, high voltage can be extracted from the lithium-sulfur battery.

### Separator

As the separator, any known material may be used, and examples thereof include porous polyethylenes and polypropylenes. Further, any known separator may be used after being coated.

### Electrolyte

The electrolyte may be any electrolyte as long as it contains a lithium salt, and may be selected as appropriate from those lithium salts that are used in conventional lithium ion batteries. The lithium salt may contain, for example, an anion having a fluorine element. Specific examples of the lithium salt containing an anion having a fluorine element include LiPF₆, LiBF₄, LiSbF₆, LiAsF₆, LiSO₃CF₃, and LiN(SO₂CF₃)₂ (LiTFSI). Further, the electrolyte may contain a lithium salt that contains no fluorine element, such as lithium nitrate or LiClO₄. These electrolytes may be used singly, or in combination of two or more kinds thereof.

The electrolyte may also contain an organic solvent. As the organic solvent, a carbonate-based solvent, an ether-based solvent, an ester-based solvent, an amide-based solvent, a nitrile-based solvent, or a sulfur-containing solvent may be used, or an organic solvent obtained by substituting some of the elements of any of the above-described organic solvents with fluorine may be used. Examples of the organic solvent include: carbonate-based solvents, such as propione carbonate, ethylene carbonate, dimethyl carbonate, and ethyl methyl carbonate; ether-based solvents, such as 1,3-dioxolane, 1,2-dimethoxyethane, 1,3-dimethoxypropane, 2,2,3,3-tetrafluoropropyl difluoromethyl ether, and tetrahydrofuran; ester-based solvents, such as methyl formate, methyl acetate, and γ-butyrolactone; amide-based solvents, such as N,N-dimethylacetamide and N, N-dimethylformamide; and sulfur-containing solvents, such as sulfolane, dimethyl sulfoxide, and 1,3-propane sultone.

### EXAMPLES

The present invention will now be described more concretely by way of Examples thereof; however, the present invention is not limited to the below-described Examples.

### Example 1

### Preparation of Carbon Material

A mixed solution was obtained by adding 500 g of water to 20 g of an activated carbon raw material (manufactured by Universal Engraving Systems, Inc., KD-PWSP) used as a first carbon material and 10 g of polyvinyl alcohol (PVA; manufactured by Sigma-Aldrich Co., LLC, molecular weight=9,000 to 10,000, degree of saponification=80% by mole). This mixed solution and 300 ml of zirconia beads (obtained by mixing Φ0.65-mm beads and Φ1-mm beads at a volume ratio of 1:1) were placed in a 2-L plastic bottle, and a 30-hour bead mill pulverization treatment was performed using a roller dispersion table at 2,000 rpm to obtain a slurry. The thus obtained slurry was supplied to a spray dryer along with air as a feed gas, and spray-dried to obtain a second carbon material. Using a tube furnace, this second carbon material was heated to 1,000° C. at a rate of 5° C./min in a nitrogen atmosphere and then maintained for 5 hours to perform a heat treatment, thereby obtaining a third carbon material. The thus obtained third carbon material and potassium hydroxide were mixed at a mass ratio of 1:4, and the resultant was placed in an alumina crucible, heated to 400° C. at a temperature increase rate of 10° C./min in a nitrogen atmosphere using a box furnace, and then maintained for 1 hour. Subsequently, the resultant was further heated to 750° C. at a temperature increase rate of 10° C./min to perform a 2-hour heat treatment, whereby an activation treatment was performed to obtain a fourth carbon material. The thus obtained fourth carbon material was neutralized with an addition of about 100 ml of 1-mol/l hydrochloric acid. Thereafter, the resultant was washed with about 2 L of pure water while performing suction filtration until the resulting filtrate had a pH of about 6 to obtain a wet cake. The thus obtained wet cake was dried for 12 hours in a 150° C. constant-temperature dryer, whereby a carbon material of Example 1 was obtained.

### Example 2

A carbon material of Example 2 was obtained in the same manner as in Example 1, except that the duration of the bead mill pulverization treatment was changed to 60 hours.

### Example 3

A carbon material of Example 2 was obtained in the same manner as in Example 1, except that the duration of the bead mill pulverization treatment was changed to 120 hours.

### Example 4

A carbon material of Example 3 was obtained in the same manner as in Example 1, except that, instead of the spray-drying using a spray dryer, the slurry was suction-filtered and then dried by a 24-hour heat treatment at 150° C. in the air atmosphere to obtain a second carbon material.

### Example 5

A carbon material of Example 4 was obtained in the same manner as in Example 1, except that the duration of the bead mill pulverization treatment was changed to 120 hours, and that, instead of the spray-drying using a spray dryer, the slurry was suction-filtered and then dried by a 24-hour heat treatment at 150° C. in the air atmosphere to obtain a second carbon material.

### Comparative Example 1

The activated carbon raw material used in Example 1 (manufactured by Universal Engraving Systems, Inc., KD-PWSP) itself was used as a carbon material of Comparative Example 1.

### Comparative Example 2

A carbon material of Comparative Example 2 was obtained in the same manner as in Example 1, except that the PVA was not added in the bead mill pulverization treatment.

### Comparative Example 3

A carbon material of Comparative Example 3 was obtained in the same manner as in Example 2, except that the PVA was not added in the bead mill pulverization treatment.

### Comparative Example 4

A spherical phenolic resin (manufactured by AIR Water Bellpearl Inc., BELLPEARL R100) was heated to 600° C. at a rate of 5° C./min in a nitrogen atmosphere, and then maintained for 5 hours to perform a heat treatment, thereby obtaining a spherical carbide. The thus obtained spherical carbide and potassium hydroxide were mixed at a mass ratio of 1:6, and the resultant was heated to 400° C. at a temperature increase rate of 10° C./min in a nitrogen atmosphere and then maintained for 1 hour, after which the resultant was further heated to 900° C. at a temperature increase rate of 10° C./min to perform a 2-hour heat treatment, whereby an activation treatment was performed to obtain a carbon material of Comparative Example 4.

### Evaluation of Pore Distribution

For the above-obtained carbon materials, the volume of open pores (pore size: 0.4 nm to 100 nm) into which a gas could penetrate was measured using a surface area/pore analyzer (trade name: NOVA TOUCH, manufactured by Anton Paar GmbH). After dehydrating each carbon material at 150° C. for 1 hour under vacuum deaeration, the nitrogen adsorption amount was measured using nitrogen as an adsorbent at 77 K in a pressure range of 0.0001 Torr to 760 Torr, and the thus measured nitrogen adsorption amount was defined as the volume of open pores. Further, the quenched solid density functional theory (QSDFT method) was applied to the thus obtained adsorption isotherm to calculate the pore distribution. In the QSDFT method, fitting was performed using a cylindrical pore model. The pore volume in a pore size range of 0.4 nm to 100 nm and the pore volume in a pore size range of 1.4 nm to 5.0 nm are shown in Table 1 as “Pore volume w” and “Pore volume n”, respectively.

### Specific Surface Area

The specific surface area was measured by a nitrogen gas adsorption method (multi-point method) using a surface area/pore analyzer (trade name: NOVA TOUCH, manufactured by Anton Paar GmbH). The results thereof are shown in Table 1.

### Primary Particle Size

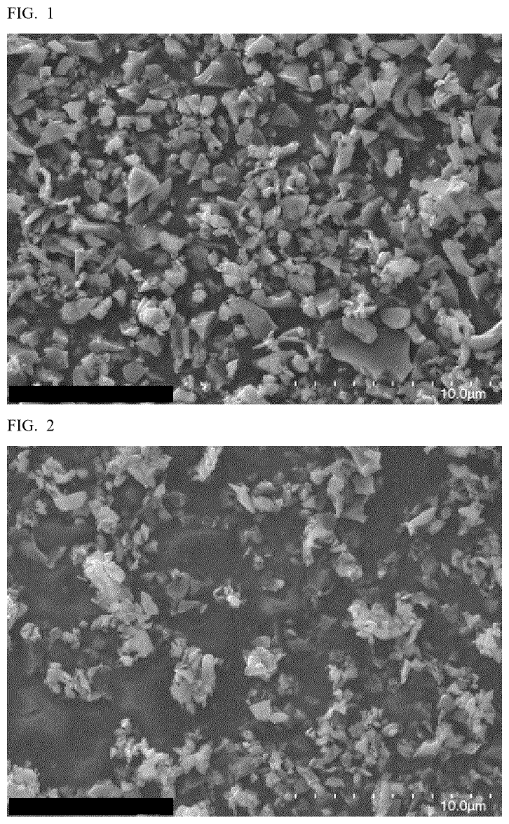

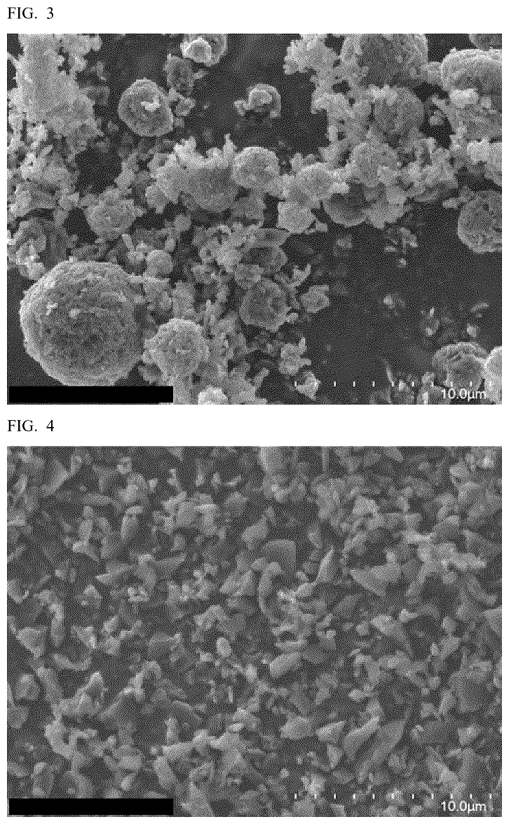

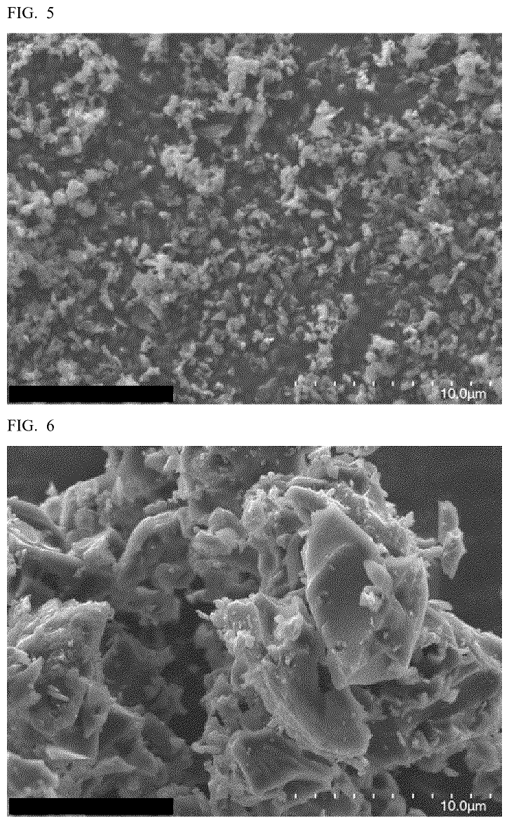

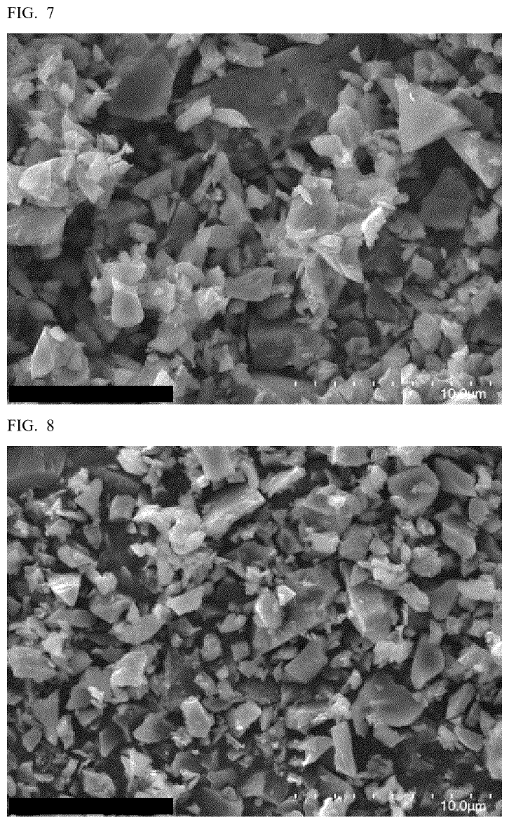

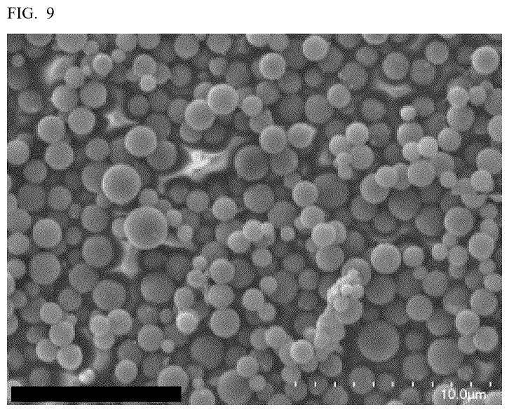

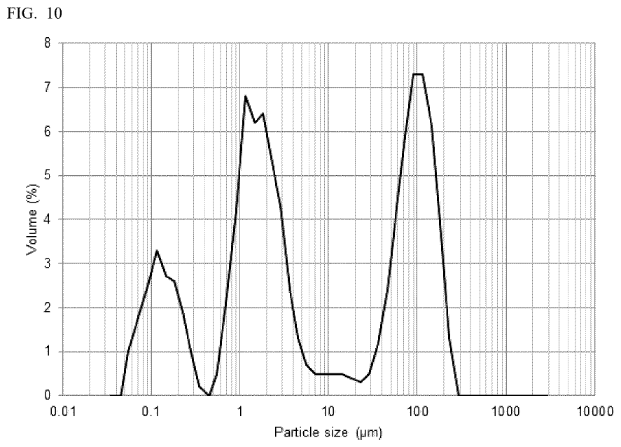

Using a scanning electron microscope (SEM), an SEM image in which the outlines of primary particles constituting secondary particles were recognizable was obtained at a magnification in a range of ×1,000 to ×10,000 depending on the particle size. On this SEM image, 200 primary particles each having a recognizable outline were selected, and the longest distance between two arbitrary points on the outline (maximum Feret diameter) was determined for each of the selected primary particles. An arithmetic mean of the thus obtained values of maximum Feret diameter was calculated to determine the primary particle size in terms of the average particle size of the primary particles. The results thereof are shown in Table 1. The SEM images of the carbon materials obtained in Examples 1 to 5 and Comparative Examples 1 to 4 are shown in FIGS. 1 to 9, respectively.

### Particle Size Distribution

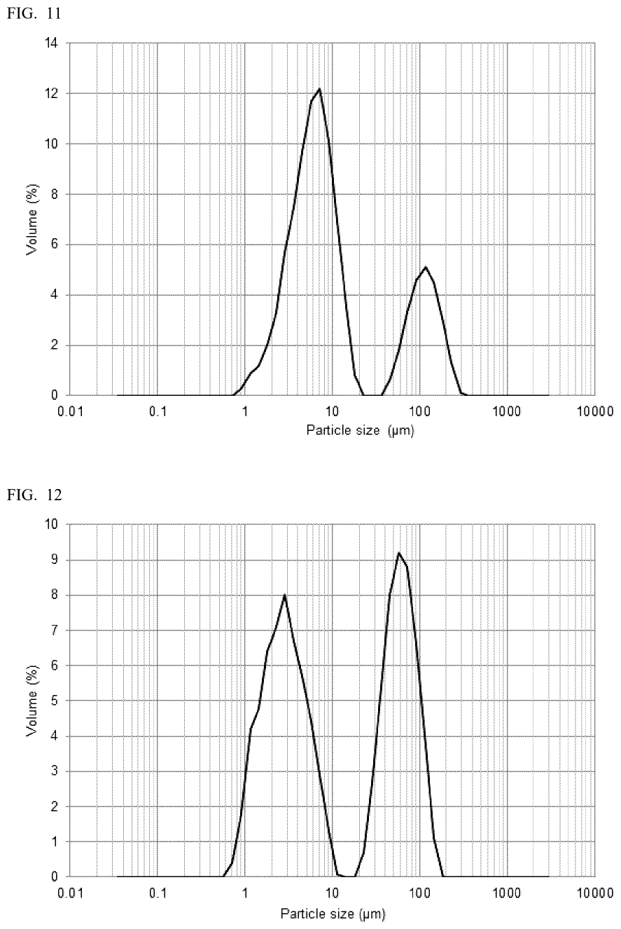

The volume-based particle size distribution was measured using a laser diffraction-type particle size distribution analyzer (MASTERSIZER 2000, manufactured by Malvern Panalytical Ltd.). A measurement sample was prepared as follows. A dispersant (ADEKA PLURONIC L-44, manufactured by ADEKA Corporation) in an amount of 2 mL was diluted with 170 mL of water medium, and the resultant was dispersed using a touch mixer to obtain a diluted dispersant. An appropriate amount of each carbon material was put into a test tube along with 2.5 mL of water and 2.5 mL of the diluted dispersant such that the laser intensity of the analyzer was in an appropriate range, and the resultant was subsequently dispersed for a few seconds using a touch mixer, after which a 120-second ultrasonic dispersion treatment was performed to obtain a measurement sample. The volume-average particle size was calculated as the 50% particle size D₅₀, which is the particle size at which the cumulative volume from the small particle size side was 50% in the volume-based particle size distribution. In addition, the 10% particle size D₁₀ and the 90% particle size D₉₀ were calculated as values at which the cumulative volume from the small particle size side was 10% and 90%, respectively, and the D₉₀ was divided by D₁₀ to determine the particle size distribution (D₉₀/D₁₀). The results thereof are shown in Table 1. Further, the particle size distribution curves obtained for the carbon materials of Example 1 and Comparative Examples 1 and 2 are shown in FIGS. 10 to 12, respectively.

### Content Analysis of Metal Elements

The content of potassium (K) and that of zirconium (Zr) in each carbon material of Examples 1 to 5 and Comparative Examples 1 and 2 were measured by inductively-coupled plasma (ICP) emission spectrometry. Specifically, each carbon material was thermally decomposed with nitric acid using a microwave sample decomposer, and subsequently measured at room temperature using standard samples for each of K and Zr and an ICP emission spectrophotometer manufactured by PerkinElmer Co., Ltd. (OPTIMA 8300). The results thereof are shown in Table 1.

TABLE 1

| | | | | Primary particle | | | | | | | | | | | |
|---|---|---|---|---|---|---|---|---|---|---|---|---|---|---|---|
| | | | | size | | | | | | | | | | Content of | |
| | Pulve- | | | Second | | Specific | Pore | Pore | | | | | Peak | metal | |
| | rization | | | carbon | Carbon | Surface | volume | volume | | | | | pore | elements | |
| | time | | Drying | material | material | Area | w | n | D₁₀ | D₅₀ | D₉₀ | D₉₀/ | size | Zr | K |
| | (h) | PVA | method | (μm) | (μm) | (m²/g) | (ml/g) | (ml/g) | (μm) | (μm) | (μm) | D₁₀ | (nm) | (ppm) | (ppm) |
| Example1 | 30 | Used | Spray- | 1.10 | 1.10 | 2156 | 0.99 | 0.84 | 0.15 | 2.70 | 134.00 | 893.33 | 2.3 | 29 | 1800 |
| | | | drying | | | | | | | | | | | | |
| Example2 | 60 | Used | Spray- | 0.91 | 0.85 | 1636 | 1.00 | 0.79 | 0.18 | 6.60 | 137.10 | 761.67 | 2.3 | 100 | 1800 |
| | | | drying | | | | | | | | | | | | |
| Example3 | 120 | Used | Spray- | 0.50 | 0.58 | 1830 | 1.20 | 0.77 | 0.87 | 6.70 | 79.23 | 91.07 | 3.1 | 210 | 1500 |
| | | | drying | | | | | | | | | | | | |
| Example4 | 30 | Used | Suction- | 1.30 | 1.20 | 1830 | 1.00 | 0.88 | 0.13 | 2.60 | 150.60 | 1158.46 | 2.3 | 390 | 2800 |
| | | | filtered | | | | | | | | | | | | |
| Example5 | 120 | Used | Suction- | 0.57 | 0.62 | 1790 | 1.20 | 0.85 | 0.13 | 4.90 | 87.68 | 674.46 | 2.3 | 110 | 9300 |
| | | | filtered | | | | | | | | | | | | |
| Comparative | — | Not | — | — | 3.10 | 1642 | 0.58 | 0.54 | 2.79 | 7.30 | 121.20 | 43.44 | 1.8 | <2 | 10000 |
| Example1 | | used | | | | | | | | | | | | | |
| Comparative | 30 | Not | Spray- | 2.00 | 2.00 | 1874 | 1.00 | 0.88 | 1.52 | 6.60 | 84.34 | 55.49 | 2.5 | 83 | 5500 |
| Example2 | | used | drying | | | | | | | | | | | | |
| Comparative | 60 | Not | Spray- | 1.60 | 1.70 | 1878 | 1.10 | 0.87 | 1.13 | 4.90 | 137.70 | 122.00 | 2.5 | — | — |
| Example3 | | used | drying | | | | | | | | | | | | |
| Comparative | — | Not | — | — | 1.50 | 3448 | 1.90 | 1.80 | 1.75 | 6.50 | 100.60 | 57.49 | 3.0 | — | — |
| Example4 | | used | | | | | | | | | | | | | |

The longer the pulverization time, the smaller was the primary particle size. Further, the addition of PVA allowed an efficient reduction in the primary particle size of the activated carbon raw material. Moreover, in those cases where PVA was added, the D₁₀ value was small, and the value of the particle size distribution D₉₀/D₁₀ was large. When the value of the particle size distribution D₉₀/D₁₀ was large, the below-described porosity of positive electrode active material layer was low, and the packing property of particles was improved. In all of the carbon materials of Examples and Comparative Examples, the volume of pores of about 2 nm in size was increased by the KOH activation treatment.

From FIGS. 10, 11, and 12, comparing the carbon material of Comparative Example 1 and the carbon material of Comparative Example 2, it is seen that the particle size peaks were shifted to the small particle size side as a whole by the use of a bead mill. In addition, comparing the carbon material of Comparative Example 2 and the carbon material of Example 1, it is seen that a peak of small particles appeared at about 0.1 μm due to the addition of PVA. From these results, it is believed that the porosity of an electrode plate is reduced by efficient packing of small particles between particles. It is noted here that a peak of small particles appeared at about 0.1 μm also for the carbon materials of Examples 2 to 5.

### Preparation of Sulfur-Carbon Composite

Each carbon material obtained in Examples and Comparative Examples was mixed with sulfur (99.99%; manufactured by Kojundo Chemical Lab. Co., Ltd.) at a mass ratio of 1:1. The thus obtained mixture was heated at 155° C. for 3 hours in a heat-resistant and pressure-resistant container. Subsequently, this mixture was placed in a stainless steel container, which was then hermetically sealed and heated at 300° C. for 24 hours, whereby a sulfur-carbon composite was obtained.

### Production of Positive Electrode

To a mixture obtained by mixing 30 parts by mass of the thus obtained sulfur-carbon composite, 3.6 parts by mass of acetylene black, 0.71 parts by mass of a styrene-butadiene rubber (SBR), and 2 parts by mass of carboxymethylcellulose (CMC), 0.89 parts by mass of polyvinylpyrrolidone (PVP) and 64 parts by mass of water were added, and the resultant was dispersed and dissolved to prepare a slurry. The thus prepared slurry was applied and dried onto a current collector such that 1.6 mg of sulfur was incorporated per unit area (1 cm²), and the resulting coated electrode plate was cut at a size of 3 cm×5 cm and then pressed at 3.7 ton (with a pressure of about 24 MPa) using a roll press machine, whereby a positive electrode was obtained.

### Measurement of Porosity of Positive Electrode Acquisition of Cross-Sectional SEM Image of Positive Electrode

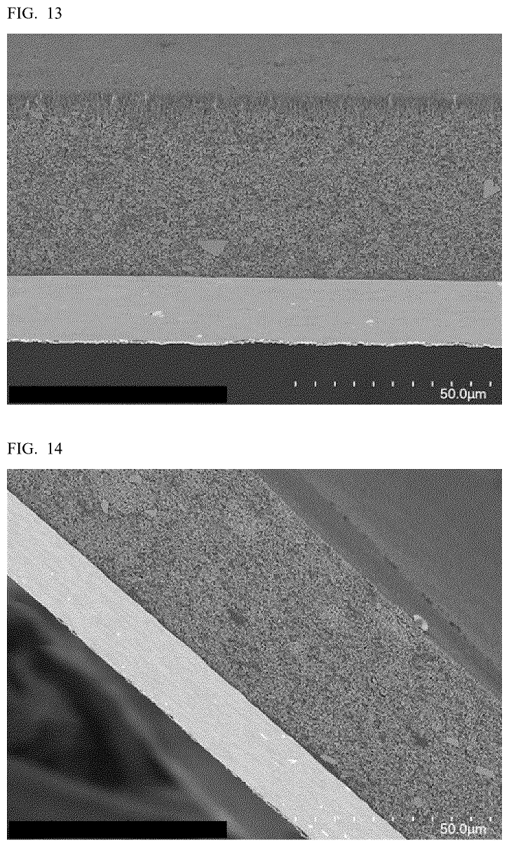

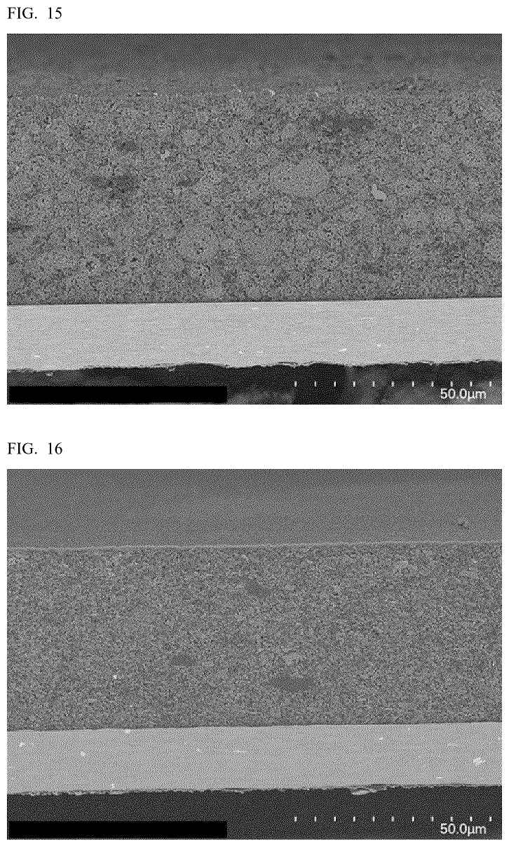

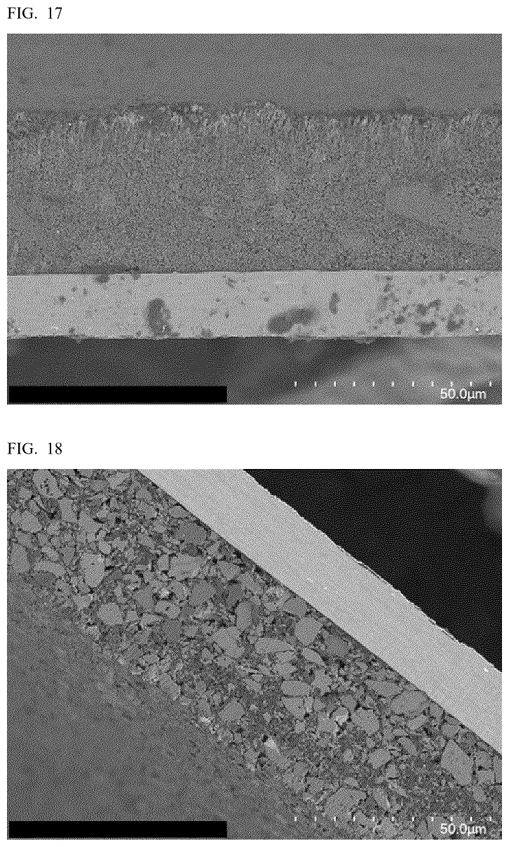

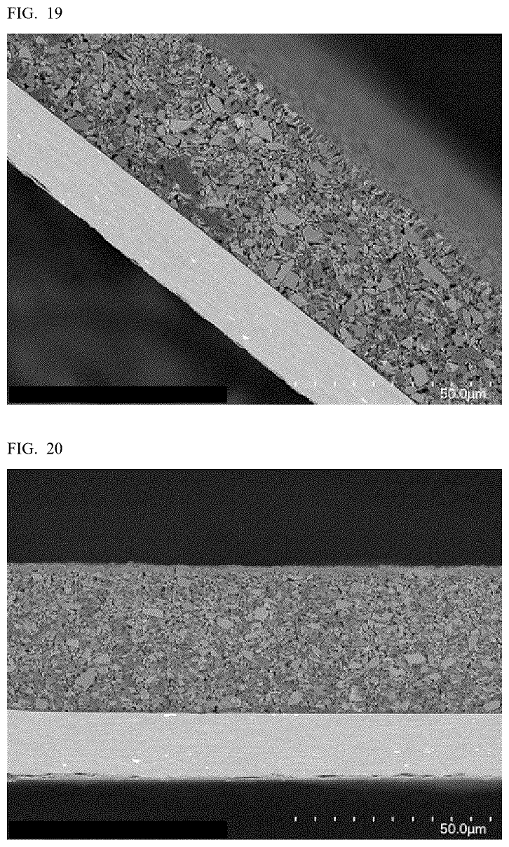

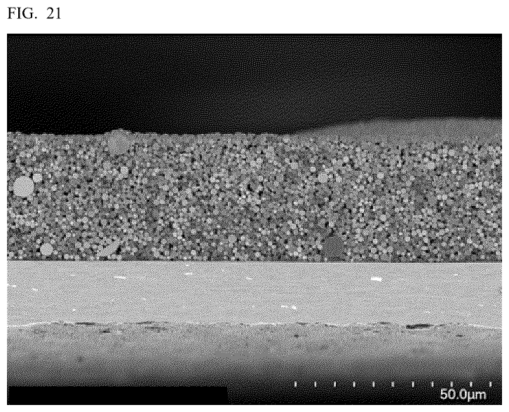

The thus obtained positive electrode was processed and cut using a cross-section polisher (CP), and a reflected electron image of the resulting cross-section of a cathode active material layer was captured under a scanning electron microscope (SEM). As for the image capturing conditions, the accelerating voltage was 5.00 kV, the working distance (WD) was 6 mm to 8 mm, and the magnification was ×1,000. FIGS. 13 to 21 show the cross-sectional SEM images of the positive electrodes that were obtained in Examples 1 to 5 and Comparative Examples 1 to 4, respectively.

Based on the thus obtained cross-sectional SEM image of each positive electrode, the porosity was calculated by the following method. Specifically, image processing was performed as follows using a free software Image J Fiji.
(1) The captured cross-sectional SEM image was loaded to Image J, and an area of 30 μm×90 μm was specified.
(2) By a threshold operation, the brightness of the gray-scale image was binarized (0 or 255). The threshold of the brightness was set at 75. As a result of this operation, void parts (black) had a threshold of 255, while non-void parts (white) had a threshold of 0.
(3) The porosity was calculated in percentage by dividing the number of pixels of the void parts by a sum of the number of pixels of the void parts and the number of pixels of the non-void parts. The results thereof are shown in Table 2.

### Lithium-Sulfur Secondary Battery

Fluoroethylene carbonate (FEC) and dimethyl carbonate (DMC) were mixed at a volume ratio of 1:1 to obtain a mixed solvent. Lithium hexafluorophosphate (LiPF₆) was dissolved in the thus obtained mixed solvent to a concentration of 1.0 mol/L to prepare a nonaqueous electrolyte solution.

A lead electrode was attached to the above-obtained positive electrode, and a separator formed of a porous polypropylene (CELGARD 2400) was arranged thereon, after which these members were placed in a bag-shaped laminated pack. Subsequently, this laminated pack was vacuum-dried at 50° C. to remove water adsorbed to the members. Thereafter, metallic lithium of a negative electrode provided on a stainless steel (SUS) foil was arranged in the laminated pack in such a manner to face the positive electrode through the porous polypropylene, and the nonaqueous electrolyte solution was injected into the laminated pack, which was then sealed to obtain a laminated-type lithium-sulfur secondary battery as an evaluation battery. Using the thus obtained evaluation battery, the following battery properties were evaluated.

### Evaluation of Charge-Discharge Cycle Capacity Retention Rate

The evaluation battery was placed in a 25° C. incubator, and a cycle capacity retention rate evaluation test was conducted. Specifically, this test was conducted at a charge-discharge voltage in a range of 1.0 V to 3.0 V. As a discharge current, a current value for extraction of 0.1 C capacity was applied. The discharge capacity in the first cycle immediately after the start of discharging, Qcyc(1) (mAh/g), was measured. Thereafter, charging and discharging were repeated to measure the discharge capacity in the second cycle (Qcyc(2)), the discharge capacity in the fifth cycle (Qcyc(5)), and the discharge capacity in the tenth cycle (Qcyc(10)). The results thereof are shown in Table 2.

For each sample, the discharge current was applied at a current value for extraction of 0.1 C capacity in the first to the third cycles; the discharge current was applied at a current value for extraction of 0.2 C capacity in the fourth cycle; and the discharge current was applied at a current value for extraction of 2.0 C capacity in the fifth cycle. The discharge capacity in the fourth cycle (R(0.2 C) and that in the fifth cycle (R(2.0 C) were measured. It is noted here that, as a charge current, a current value for extraction of 0.1 C capacity was applied in all of the cycles. Further, the thus measured (R(2.0 C) of each sample was divided by (R(0.2 C) to calculate the rate characteristic Rc (=100×R(2.0 C)/R(0.2 C)) (%). It is noted there that the discharge capacities were calculated in terms of per mass of sulfur. The thus obtained results are shown in Table 2.

The batteries of Examples 1 to 5 were each charged and discharged up to the 30th cycle under the above-described conditions of the cycle capacity retention rate evaluation test, and the discharge capacity Qcyc(30) of each battery was measured. Further, the thus obtained value of Qcyc(30) was divided by Qcyc(2) to calculate the capacity retention rate after the 30th cycle, Pcyc(=100×Qcyc(30)/Qcyc(2)) (%). The results thereof are shown in Table 3.

TABLE 2

| | | | | | | | Rate | |
|---|---|---|---|---|---|---|---|---|
| | Qcyc(10) | Qcyc(5) | Qcyc(2) | Qcyc(1) | R (2.0C) | R (0.2C) | characteristic | Porosity |
| | (mAh/g) | (mAh/g) | (mAh/g) | (mAh/g) | (mAh/g) | (mAh/g) | Rc (%) | (%) |
| Example1 | 984 | 994 | 1052 | 1820 | 951 | 1007 | 94.4 | 2.5 |
| Example2 | 1028 | 1031 | 1078 | 1758 | 943 | 1022 | 92.3 | 1.8 |
| Example3 | 996 | 1020 | 1079 | 1780 | 1027 | 1099 | 93.4 | 5.6 |
| Example4 | 998 | 1003 | 1054 | 1845 | 952 | 1017 | 93.6 | 1.7 |
| Example5 | 1027 | 1036 | 1091 | 1788 | 1021 | 1077 | 94.8 | 1.4 |
| Comparative | 669 | 685 | 765 | 1725 | 630 | 684 | 92.1 | 10.4 |
| Example1 | | | | | | | | |
| Comparative | 772 | 776 | 819 | 1753 | 713 | 797 | 89.5 | 10.4 |
| Example2 | | | | | | | | |
| Comparative | 842 | 846 | 899 | 1768 | 732 | 837 | 87.5 | 4.5 |
| Example3 | | | | | | | | |
| Comparative | 743 | 829 | 885 | 1697 | 698 | 836 | 83.5 | 12.0 |
| Example4 | | | | | | | | |

A smaller primary particle size of the carbon material tended to result in a larger value of Qcyc(2). In Examples, the Qcyc values were larger and a higher capacity was maintained even after ten charge-discharge cycles as compared to Comparative Examples. In addition, a high capacity was observed even in high-rate discharge at 2 C. It is believed that a smaller primary particle size leads to a shorter diffusion distance of lithium ions in the pores, allowing battery reactions to take place efficiently. Further, it can be said that the particle size distribution D₉₀/D₁₀ was high and the particle size distribution was broad in Examples. In such a case, the particles of the carbon material can be packed densely, and the porosity of the electrode plate is thereby reduced. It is believed that, as a result, battery reactions take place efficiently and the battery exhibits a high capacity.

TABLE 3

| | | | Capacity |
|---|---|---|---|
| | Qcyc(30) | Qcyc(2) | retention rate |
| | (mAh/g) | (mAh/g) | Pcyc (%) |
| Example1 | 923 | 1052 | 88 |
| Example2 | 799 | 1078 | 74 |
| Example3 | 729 | 1079 | 68 |
| Example4 | 944 | 1054 | 90 |
| Example5 | 866 | 1091 | 79 |

It is believed that an increase in the particle size distribution D₉₀/D₁₀ leads to an improvement in the packing property of particles, as a result of which dissociation of active materials during repeated charging and discharging is inhibited, and the capacity retention rate is improved.

The disclosure of Japanese Patent Application No. 2022-073324 (filing date: Apr. 27, 2022) is incorporated herein by reference in its entirety. All documents, patent applications, and technical standards cited in the present description are incorporated herein by reference to the same extent as in cases where the individual documents, patent applications, and technical standards are specifically and individually described to be incorporated by reference.

What is claimed is:

1-18. (canceled)

19. A method of producing a carbon material for a lithium-sulfur battery, the method comprising:
performing a wet pulverization treatment of a mixture comprising a first carbon material, a dispersant, and a liquid medium to obtain a slurry;
removing at least a portion of the liquid medium from the slurry to obtain a second carbon material;
performing a heat treatment of the second carbon material to obtain a third carbon material; and
performing an activation treatment of the third carbon material to obtain a fourth carbon material.

20. The method of producing a carbon material for a lithium-sulfur battery according to claim 19, wherein an average primary particle size of the second carbon material is 1.5 μm or less.

21. The method of producing a carbon material for a lithium-sulfur battery according to claim 19, wherein the first carbon material is an activated carbon having a peak pore size in a range of 1.0 nm to 5.0 nm.

22. The method of producing a carbon material for a lithium-sulfur battery according to claim 19, wherein the second carbon material is a spray-dried product of the slurry.

23. The method of producing a carbon material for a lithium-sulfur battery according to claim 19, wherein the dispersant comprises a thickening agent.

24. The method of producing a carbon material for a lithium-sulfur battery according to claim 19, wherein the heat treatment of the second carbon material is carried out at a temperature in a range of 600° C. to 1,500° C.

25. The method of producing a carbon material for a lithium-sulfur battery according to claim 19, wherein the activation treatment comprises contacting the third carbon material with an activator at a temperature in a range of 650° C. to 900° C.

26. The method of producing a carbon material for a lithium-sulfur battery according to claim 19, wherein the wet pulverization treatment is performed using a bead mill.

27. A carbon material for a lithium-sulfur battery, having: an average primary particle size that is 1.5 μm or less; a peak pore size in a range of 1.0 nm to 5.0 nm; a pore volume that is 0.6 ml/g or more; and a ratio D90/D10, which is a ratio of a 90% particle size D90 with respect to a 10% particle size D10 in a volume-based cumulative particle size distribution, that is 60 or higher.

28. The carbon material for a lithium-sulfur battery according to claim 27, wherein the peak pore size is in a range of 1.5 nm to 4.0 nm.

29. The carbon material for a lithium-sulfur battery according to claim 27, having a specific surface area that is 1,000 m2/g or more.

30. The carbon material for a lithium-sulfur battery according to claim 27, wherein the 50% particle size D50 in the volume-based cumulative particle size distribution is in a range of 2 μm to 10 μm.

31. The carbon material for a lithium-sulfur battery according to claim 27, wherein the ratio D90/D10 is 500 or higher.

32. The carbon material for a lithium-sulfur battery according to claim 27, wherein the 10% particle size D10 is 1 μm or less and the 90% particle size D90 is 50 μm or more.

33. A cathode material for a lithium-sulfur battery, comprising:
the carbon material for a lithium-sulfur battery according to claim 27; and
sulfur.

34. A positive electrode for a lithium-sulfur battery, comprising:
a current collector; and
a cathode active material layer which is arranged on the current collector and comprises the cathode material for a lithium-sulfur battery according to claim 33.

35. The positive electrode for a lithium-sulfur battery according to claim 34, wherein the cathode active material layer has a porosity that is 10.0% or less.

36. A positive electrode for a lithium-sulfur battery, comprising:
a current collector; and
a cathode active material layer arranged on the current collector,
wherein the cathode active material layer comprises: a carbon material for a lithium-sulfur battery having an average primary particle size that is 1.5 μm or less; and a sulfur-containing cathode material for a lithium-sulfur battery, and
wherein the cathode active material layer has a porosity of 10.0% or less.
